(19) United States
(12) Patent Application Publication
(10) Pub. No.: US 2015/0242914 A1
(43) Pub. Date: Aug. 27, 2015

(54) METHOD AND SYSTEM FOR MANAGING SOURCING PROGRAM REQUESTS

(71) Applicant: PERFECT COMMERCE, LLC, Newport News, VA (US)

(72) Inventors: Jason E. Vincelette, Newport News, VA (US); Nathan E. Lienard, Williamsburg, VA (US); Barclay D. Schell, Williamsburg, VA (US)

(21) Appl. No.: 14/616,860

(22) Filed: Feb. 9, 2015

Related U.S. Application Data
(63) Continuation of application No. 13/451,221, filed on Apr. 19, 2012, now abandoned.
(60) Provisional application No. 61/476,787, filed on Apr. 19, 2011.

(51) Int. Cl. G06Q 30/06

(52) U.S. Cl. CPC G06Q 30/0611

(57) ABSTRACT

A method for managing sourcing requests. The method utilizes a computer interface to collect the sourcing request and present that sourcing request to a sourcing agent. The method also utilizes a computer interface to allow the sourcing agent to initiate and conduct a sourcing protocol that provides a list of results from which the sourcing agent can select the most appropriate sourcing solution for an organization. A computer program product comprising a non-transitory computer medium with instructions to collect sourcing request data, determine whether the sourcing program needs modification and modifying the sourcing program.

### CROSS REFERENCE TO RELATED APPLICATIONS

The present application is a continuation of U.S. patent application Ser. No. 13/451,221 filed on Apr. 19, 2012, which claims priority under 35 U.S.C. §119 to U.S. Provisional Application Ser. No. 61/476,787 filed on Apr. 19, 2011, entitled “System and Method for Processing and Maintaining Supply Requests,” which is incorporated herein by reference in its entirety.

### BACKGROUND

1. Field of the Invention

The invention disclosed herein relates generally to a method and system for managing sourcing program requests for an organization by providing a configurable, template based requesting tool.

2. Background of the Invention

Corporate sourcing or procurement departments frequently use contract management and sourcing software applications, which may include reverse auction software, to reduce spend under management and to increase spend efficiency, in order to create cost savings. The problem with most of these applications is that the majority of corporate employees outside of the sourcing or procurement department have no interest in actively using the procurement to source new or existing purchasing contracts. In addition, the current systems require additional expenses such as obtaining user licenses and training for employees that will infrequently use the application.

Most companies train designated employees as specialists to use sourcing software actively. These specialists either self-identify spend purchases to target or receive requests from elsewhere in the organizational structure. When a specialist receives requests for sourcing contracts from elsewhere in the organizational structure, the sourcing requests typically arrive by phone, email, fax, or in person and frequently there is no project management or communication tracking used to manage these sourcing requests. More importantly, current available purchasing request and sourcing management applications do not address the need to evaluate existing sourcing programs in order to lower spend and increase productivity.

### SUMMARY

It is, therefore, an object of the present invention to provide a computer implemented method and system that avoids the disadvantages of the prior art. An object of the present invention is to provide a system that enables companies to manage spend. Another object of the system is to facilitate management of spend by allowing non-sourcing professionals to request review of spend management programs and current purchasing contracts. Another object of the present invention is to provide a requesting tool for non-sourcing professionals.

One object of the present inventions provides a method for managing sourcing programs, in accordance with one object of the present invention. In a first step of the method, a first computer interface collects a sourcing request. In a subsequent step, the first computer interface presents the sourcing request for a sourcing program to a sourcing agent in a sourcing department. In a further step, the sourcing agent is enabled to initiate a sourcing protocol through a second computer interface. In a subsequent step, the second computer interface receives a list of sourcing results in response to the sourcing protocol. In a further embodiment, the sourcing request comprises a request for a change in an existing sourcing program, wherein the request for a change comprises a request for additional purchases, new purchases, or both.

Another object of the present invention is to provide a virtual server configured to manage a sourcing program. The virtual server comprises a non-transitory computer readable medium accessible to said virtual server; and instructions stored on the non-transitory computer readable medium, responsive to execution within said virtual server and causing the virtual server to perform the steps of a method of managing sourcing programs as described above.

Another object of the present invention is to provide a method for managing sourcing requests. The method comprises the steps of providing a system for submission of sourcing requests, collecting sourcing request data, storing said sourcing request data in a database, alerting a sourcing agent of the sourcing request, enabling the sourcing agent to transfer data from the sourcing request into an RFx. In a further object of the present invention, the method is implemented on a computer.

A computer implemented method for managing sourcing requests comprising the following steps: receiving one or more sourcing evaluation requests for changes in an existing sourcing program, assigning said sourcing request to a sourcing agent to initiate a sourcing protocol, obtaining sourcing proposals from the sourcing protocol, determining whether the existing sourcing program should be modified based on the results of the sourcing protocol, and modifying the existing sourcing program or maintaining the existing sourcing program.

A computer system for optimizing sourcing costs that comprises the following elements: a sourcing department computer configured to receive a sourcing request for a change or evaluation of an existing sourcing program; a requesting department computer connected with said sourcing department computer, wherein said requesting department computer has access to a user interface comprising at least one sourcing request template for transmitting said sourcing request for a change or evaluation of the existing sourcing program; and a server connecting said requesting department computer and said sourcing department computer, wherein said server is equipped with one or more software applications that permit a requesting department to submit said sourcing request for a change or evaluation of said existing sourcing program or creation of a new sourcing program.

Another object of the present invention is to provide a system that enables a sourcing agent to create request templates. A related object of the present invention is to provide a system that enables a sourcing agent to create and use existing User Defined Fields (UDFs) when creating templates. Another object of the present invention is to provide a system that will enable a sourcing agent to customize request status to better describe/capture the state of the request. Another object of the present invention is to provide a system that will enable a sourcing agent to assign a request to a buyer user to fulfill the request.

A further object of the present invention is to provide a computer program product for managing an organization's sourcing programs. The computer program code enables collecting data from through a first user interface in the form of a sourcing request, presenting that data through the first user interface, enabling the initiation of a sourcing protocol and presenting the results of the sourcing protocol. The computer program product is a non-transitory computer readable medium storing computer-readable program code. The computer readable program code comprises a set of instructions for collecting a sourcing request for a sourcing program through a first computer interface; presenting the sourcing request to a sourcing agent in a sourcing department through the first computer interface; enabling the sourcing agent to initiate a sourcing protocol; and receiving a list of sourcing results in response to the sourcing protocol.

In accordance with the above and other objects, a software driven request manager is disclosed. The request manager allows buyers or users within an organization to utilize the product to complete and submit request templates to a sourcing agent. In some embodiments, the request manager standardizes the process of making requests of the purchasing department by providing a configurable, template based requesting tool. Request templates minimize the back and forth that often occurs when requests are made of the purchasing departments. Visibility into how many requests are in the purchasing departments queue is centralized. Purchasing managers receive notifications upon receipt of new requests and can delegate the sourcing requests to the appropriate sourcing professional for processing. Completing the request provides both the requestor and purchasing professional with historical reference summarizing the result. Fulfilled requests may be tied to one or more sourcing events and/or contracts.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows a Request Manager home page according to an embodiment of the present invention.

FIG. 2 shows a Request Template page according to an embodiment of the present invention.

FIG. 3 shows a blank Template according to an embodiment of the present invention.

FIG. 4 shows an example of an initial request notification according to an embodiment of the present invention.

FIG. 5 shows a Find Request according to an embodiment of the present invention.

FIG. 6 shows an example of a Request Summary according to an embodiment of the present invention.

FIG. 7 shows a Requestor Self Registration page according to an embodiment of the present invention.

FIG. 8 shows a category selection window according to an embodiment of the present invention.

FIG. 9 shows a UDF selection window according to an embodiment of the present invention.

FIG. 10 shows a Create Request page according to an embodiment of the present invention.

FIG. 11 shows a Template Selection page according to an embodiment of the present invention.

FIG. 12 shows a Completed Request page according to an embodiment of the present invention.

FIG. 13 shows an example of an initial notification according to an embodiment of the present invention.

FIG. 14 shows a Request Manager home page according to an embodiment of the present invention.

FIG. 15 shows an Open Requests page according to an embodiment of the present invention.

FIG. 16 shows a Sourcing Agents view of a Request according to an embodiment of the present invention.

FIG. 17 shows a Request Summary Tab according to an embodiment of the present invention.

FIG. 18 shows a Privileges Screen according to an embodiment of the present invention.

FIG. 19 shows a UDF Administration screen according to an embodiment of the present invention.

FIG. 20 shows another view of a UDF Administration screen according to an embodiment of the present invention.

FIG. 21 shows an Application Preferences—Admin screen according to an embodiment of the present invention.

FIG. 22 shows an Application Preferences—Request Manager screen according to an embodiment of the present invention.

FIG. 23 illustrates steps to rename or modify a Request status according to an embodiment of the present invention.

FIG. 24 illustrates steps to delete a Request status according to an embodiment of the present invention.

FIG. 25 illustrates steps to move a Request status according to an embodiment of the present invention.

FIG. 26 shows an Application Preferences—Notifications screen according to an embodiment of the present invention.

FIG. 27 shows Notifications Template page according to an embodiment of the present invention.

FIG. 28 shows a Template modification Drop Down window according to an embodiment of the present invention.

FIG. 29 shows a Notification modification window according to an embodiment of the present invention.

FIG. 30 shows a listing of keywords according to an embodiment of the present invention.

FIG. 31 shows a Create Report page according to an embodiment of the present invention.

FIG. 32 shows a Manage Report page according to an embodiment of the present invention.

### DESCRIPTION OF PREFERRED EMBODIMENTS

The invention summarized above may be better understood by referring to the following description, which should be read in conjunction with the accompanying drawings and claims. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

On embodiment of the present invention provides a method for managing sourcing programs. The method allows any interested party in an organization (e.g., a first user requester with access to the sourcing application) the ability to present a request for a sourcing program to a sourcing/purchasing department. In the first step of this method, a person has the ability to enter information about the sourcing request through a first computer interface. The first computer interface collects a sourcing request for a sourcing program from the interested individuals or first user requestor. In one alternative embodiment, the sourcing request data is stored in a database. In a further step, a sourcing agent is alerted once the first user requester submits the sourcing request.

As used in this application, a “sourcing program” includes an ongoing relationship or contract with a vendor for providing specific items or services, a onetime sourcing/purchasing request from a vendor, or a new contract with a vendor for a projected ongoing relationship for multiple purchases. The sourcing program also includes a group of purchases, potential purchases, or both. In other embodiments, the sourcing program may include all of an entity's actual purchases, potential purchases, or both. In one embodiment, the sourcing request is a request for a change in an existing sourcing program. In some instances, a sourcing request is made when the requestor believes a better sourcing program may be available through a different vendor, or when the requestor is dissatisfied with the quality of the products and services offered under the existing sourcing program. In other embodiments, the request for a change is a request for additional purchases, new purchases, or both. In this case, the sourcing agent uses the existing sourcing program to fulfill the request or initiates a sourcing protocol to find a more advantageous sourcing program that reduces spend and increases productivity. The request made by the requestor allows the organization to manage its purchasing decisions more efficiently as described in more detail below. As used in this application the term “sourcing request” means a request submitted to a sourcing/purchasing department to find a sourcing program for a particular product or service. The sourcing request described herein differs from a purchase order in that the sourcing request does not, in itself, result in an order for products or services but on a sourcing program to acquire such products and services.

At a second step of the method, the sourcing request for a sourcing program is presented to a sourcing agent in a sourcing department through the first computer interface or a second computer interface. The sourcing department may be a department within an organization or a third party that has the responsibility of sourcing requests for the organization. The sourcing agent is a designated individual who controls and manages the organization's spending. It is contemplated that the sourcing agent may be a single individual or multiple individuals within a purchasing department's team. The sourcing agent utilizes the computer interface provided in the method to determine what further steps need to be taken. In a further step, the sourcing agent initiates a sourcing protocol through the first computer interface or a second computer interface. The sourcing agent may also assign the request to a second sourcing agent for further processing.

Upon receipt of the sourcing request, the sourcing agent initiates a sourcing protocol. In one alternative embodiment, the sourcing agent transfers the sourcing data from the sourcing request into a sourcing protocol form. The sourcing protocol is a competitive bidding process. The competitive bidding process selected may be an RF[x], which is a Request For [x] where x can be a proposal (RFP), quotation (RFQ), information (RFI), or tender (RFT), a reverse auction, and other similar methods understood by a person of ordinary skill in the art for the fulfillment of purchase and sourcing program requests. Unlike the prior art, which provides for the initiation of purchase orders electronically, the method of the present invention allows for the request for sourcing protocols that change existing sourcing programs or create new sourcing programs helping reduce spend and increase productivity.

Once the sourcing protocol is completed, the computer interface presents a list of sourcing results in response to the sourcing protocol to the sourcing agent, the individual making the request, or both. The list of sourcing results includes one or more possible sourcing programs that the organization can implement in reducing spend and increasing productivity. If a sourcing protocol is selected by the sourcing agent, the requester is notified of the selection and results of the sourcing request. In some embodiments, the sourcing agent provides a link to a contract or to an event for the individual who initiates a sourcing request once the sourcing protocol is selected.

The “computer interface” of the present invention is an application that allows the users to interact with the computers carrying out the steps of the methods described herein. One example of the computer interface is a web page on the worldwide web or on an intranet that is designed to allow individuals to enter information and interact with the programs and computers executing the methods described herein. A person of ordinary skill in the art would understand that the type of interface is not critical to the present invention provided it has the ability to allow users to enter and review information. In some embodiments of the present invention, the computer interface may be a mobile application that allows users utilizing handheld devices to access the software that implements the method described in this application.

In one embodiment of the present invention, the first and second computer interfaces of the method are hosted on a server. A server is a computer system (physical or virtual) that performs specific tasks at the request of other programs. A server as used herein includes a physical server or a virtual server. The physical server may be located at a purchasing management service provider's location. In other embodiments, the physical server may be at the organization's location. A virtual server is software implemented version of a server that allows multiple servers to be hosed on one physical computer or on a network of computers. In some embodiments, the first computer interface is hosted on a different server than the server hosting the second computer interface. In another embodiment, the computer interfaces are hosted on different computer systems capable of communicating with each other.

In a further embodiment of the present invention, the method provides templates for the user or sourcing agent to utilize in generating a sourcing request and/or initiating a sourcing protocol. In some embodiments, an administrator creates various templates. In yet a further embodiment of the present invention, another step in the method consists of presenting status updates to an individual who initiates a sourcing request, the sourcing agent, or both. The administrator has the ability to create different types of status updates to fit the needs of the organization. The status updates have different labels depending on the status of the request, such labels include “received”, “pending”, “working”, “in RFx”, “evaluating”, and “contract award”, among others. During processing of the request, comments and/or attachments may be sent to/from sourcing agent to/from the first user requester. Other status update labels utilized are within the scope of the present invention.

The method is carried out through software that allows communication between the sourcing management application and a contract management application or/and an event management application. In one further step, custom categories are assigned to each request. In one embodiment, standard categories are present in the sourcing request management application. In further embodiments, an administrator has the ability to create additional categories. If the software implementing the method allows the sourcing management application to communicate with other contract or event management applications, at least some of the custom categories match custom categories found in such contract or event management applications. The sourcing agent may also sort and/or prioritize requests by status and/or category. Contract management or event management categories may also be used as template fields for sourcing requests.

In some embodiments of the present invention, the templates are available to different users based on specific criteria. For example, some users may only have access to templates for specific categories or requests based on the event or contract management applications. The computer interface is configured to recognize the user and present only those templates the user is authorized to utilize for submitting requests.

In a further embodiment, a system for executing a method for managing sourcing programs is described. The system comprises a virtual server configured to manage a sourcing program; a non-transitory computer readable medium accessible to said virtual server; and instructions stored on said computer readable medium, responsive to execution within said virtual server and causing the virtual server to perform the method of managing sourcing programs described above. The instructions on the non-transitory computer readable medium result in the implementation of the method of managing sourcing programs. The computer readable medium is contemplated to be any physical or virtual non-transitory component that is configured to store the set of instructions that the computer processors associated with the system use to carry out the method of the present invention. As used herein, and as will be recognized by those of ordinary skill in the art, “non-transitory” computer-readable media comprise all computer readable media, with the sole exception being a transitory, propagating signal.

An alternative embodiment of the present invention provides a computer system for optimizing sourcing costs. The first element of the computer system is a sourcing department computer configured to receive a sourcing request for a change or evaluation of an existing sourcing program or a new sourcing program. The second element of the system is a requesting department computer connected with said sourcing department computer, wherein said requesting department computer has access to a user interface comprising at least one sourcing request template for transmitting said sourcing request for a change or evaluation of the existing sourcing program or creating a new sourcing program. The third element of the system is a server connecting said requesting department computer and said sourcing department computer, wherein said server is equipped with one or more software applications that permit a requesting department to submit said sourcing request for a change or evaluation of said existing sourcing program or creation of a new sourcing program.

### Example

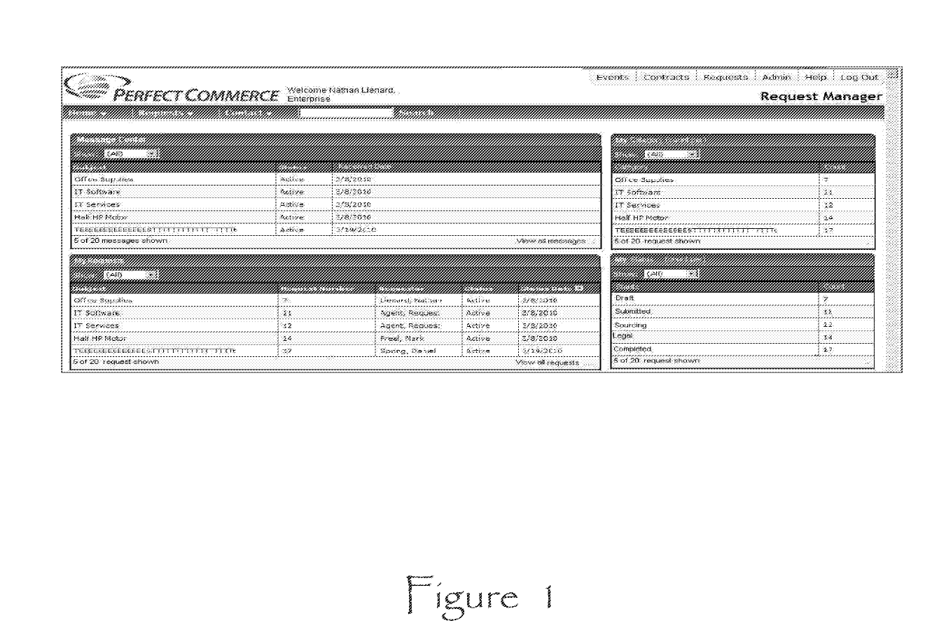

The following is an example of a computer-implemented method in accordance with one embodiment of the present invention described in FIG. 1. In the below example of one embodiment of the invention, Request Manager is the name of the interactive system to provide non-sourcing professionals a simplified tool to make requests of their sourcing team.

According to the present invention, supply requests are template driven in order to minimize the back forth between the requestor and the sourcing agent. Sourcing agents will then be able to assign a request to a buyer user to fulfill the request. The Request Manager provides the following advantages/functions: ability to create User Defined Fields (UDFs) to add to the templates ensuring all necessary and desired information is captured; customize and add statuses to meet the required business processes, add attachments to maintain all supporting information in one location, and automate and customize notifications to be sent throughout process. The tool described herein allows a sourcing group the ability to create a structured and formalized process around receiving and completing external sourcing requests. Completing the request provides both the requestor and purchasing professional with historical reference summarizing the result. Fulfilled requests may be tied to one or more sourcing events and/or contracts.

Referring to FIG. 1, Request Manager standardizes the process of making requests of the purchasing or sourcing department by providing a configurable, template based requesting tool. Visibility into the number of requests and their individual statuses is centralized. Purchasing managers receive notifications as new requests are added and can delegate requests to the appropriate sourcing professional to fulfill. FIG. 1 is an example of a home page for the Request Manager. The application more specifically allows the purchasing department to accept sourcing requests that go beyond simple purchase orders.

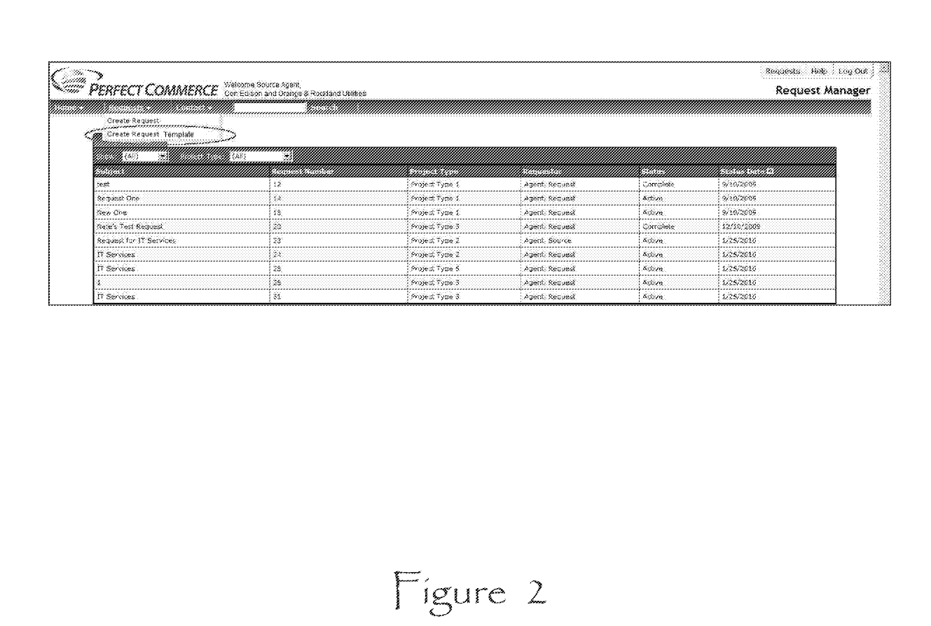

Request Templates, such as shown in FIG. 2 minimize the back and forth that often occurs when requests are made of the purchasing departments. A library of templates can be created to capture numerous types of frequently submitted requests. FIG. 3 illustrates an example of a blank template according to the present invention. These templates contain: user Defined Fields (UDFs) ensuring all necessary and desired information is captured; customized statuses to meet the required business processes; and attachments to maintain all supporting information in one location.

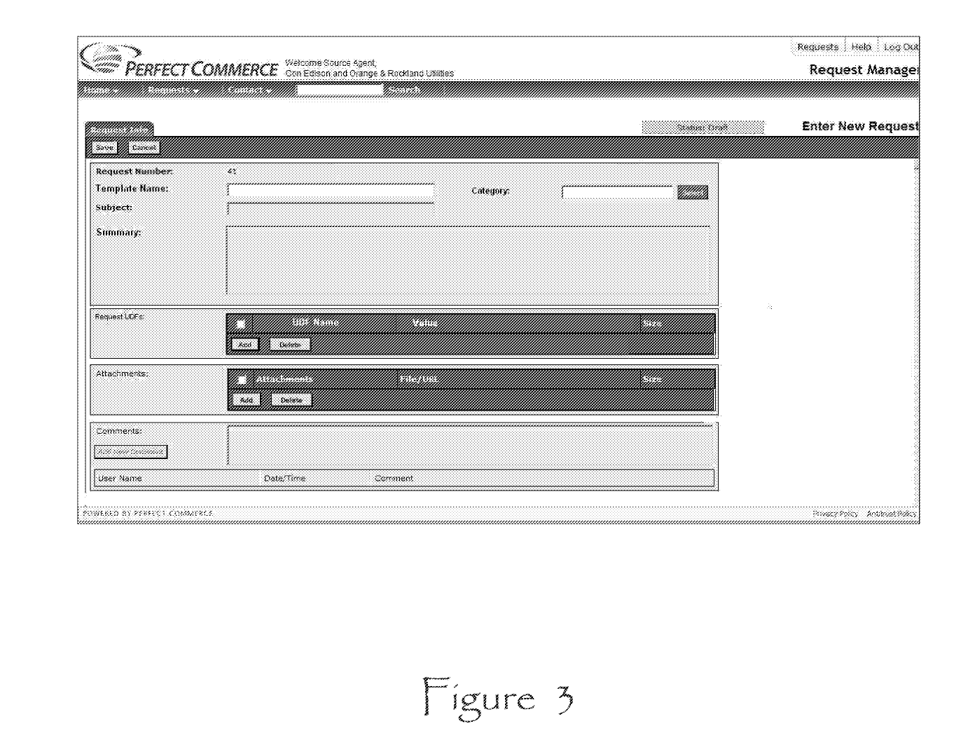

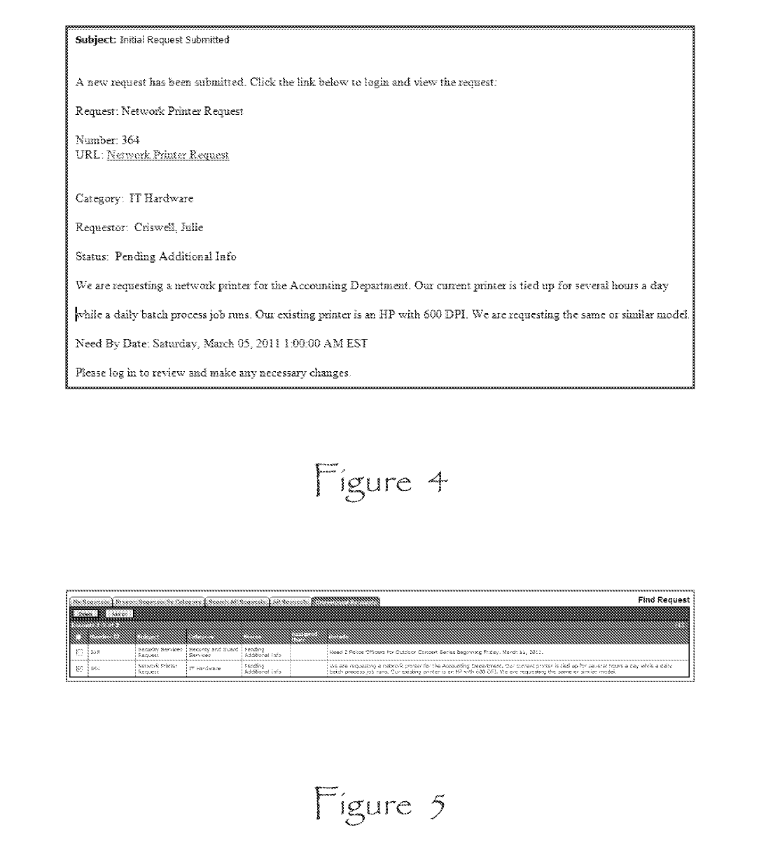

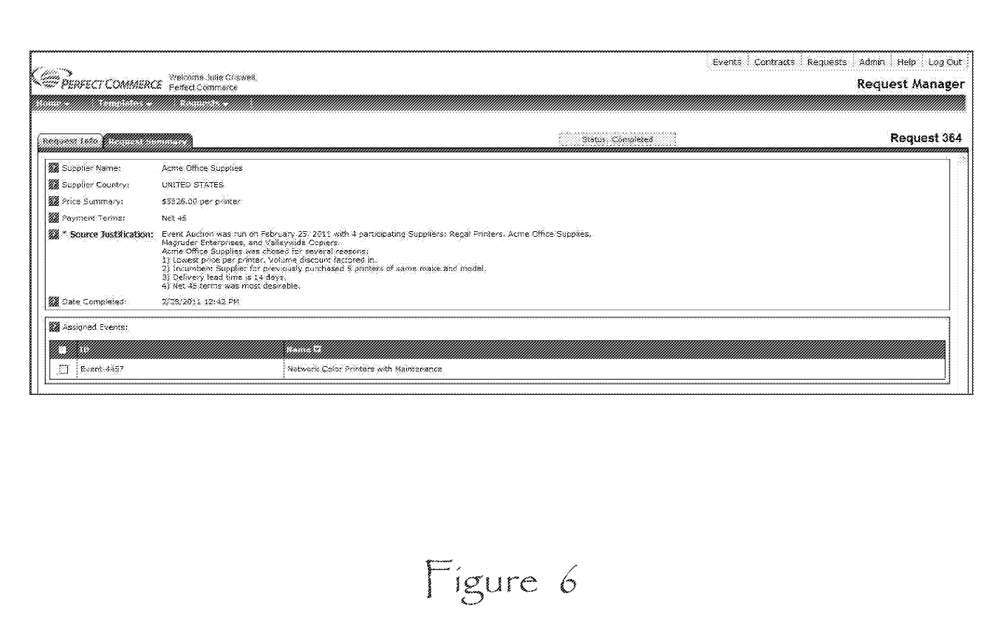

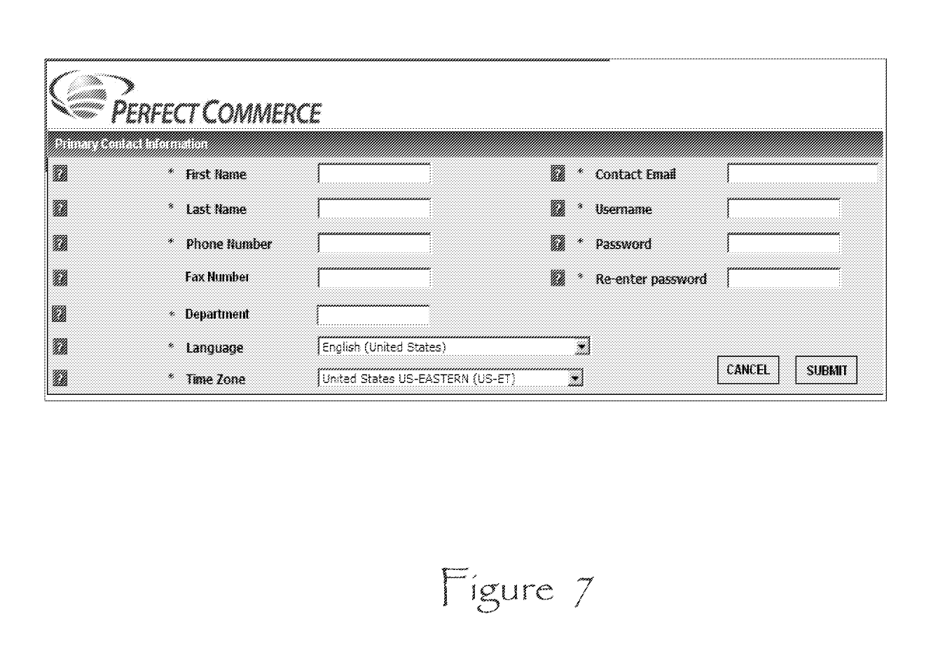

Throughout the request process, system-generated notifications are sent as a result of numerous triggers. These notifications may be customized to meet specific business needs, such as shown in FIG. 4. Using the Request Manager, requests, either singly or in multiples, are easily assigned to an appropriate individual as shown in FIG. 5. Completing the request provides both the requestor and purchasing professional with historical reference summarizing the result. FIG. 6 shows an example of a completed request. Fulfilled requests may be tied to one or more sourcing events and/or contracts.

Registration

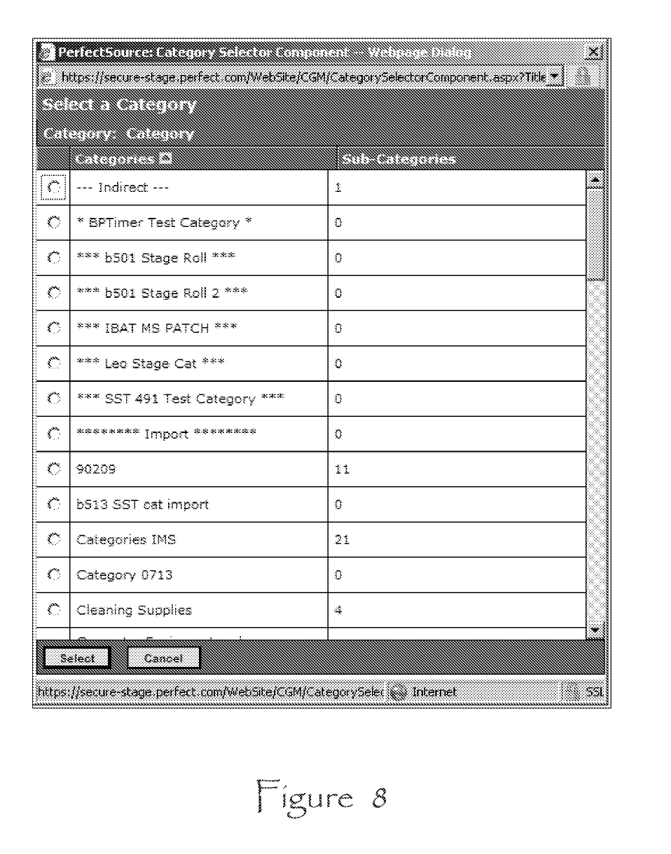

In a preferred embodiment, the first step in using the system is to register. A one-page self-registration tool (RSR) is available for potential requesters to self-register and create a user id and password. FIG. 7 shows an example of a requester self-registration form. A URL can be tied to the RSR so that sourcing groups are able to share/post it for potential requestors to click and register to be a requestor. Preferably, the fields to be included on the self-registration screen are as follows:

| | |
|---|---|
| First Name | Time Zone |
| Last Name | Email |
| Phone Number | UserName--The requester may choose |
| | their own username to access the Request |
| | Manager Templates. |
| Contact Fax | Password--The requester may choose their |
| | own password to access the Request |
| | Manager Templates. |
| Department | Re-enter Password--To ensure accuracy, |
| | the requester will need to re-enter the |
| | password previously entered in the |
| | Password field. |
| Language--The requester | |
| can use a drop down menu | |
| to select a default language | |

Once a requestor clicks submit, a “Thank You” screen is displayed stating that a confirmation email will be sent to the email address that was provided. Other forms of notification may be utilized. This notification contains a link to Request Manager, the userid, and the password. The requester clicks the link contained in the email to complete their registration and activate their account. Upon submitting their information via the RSR, a requestor defaults to a predetermined role. On another embodiment, Requester Self Registration is enabled with default permissions as assigned by the administrator so that Requesters can become Requesters simply by going to a link and registering with a valid email address. Other forms of registration as understood by a person of ordinary skill in the art are contemplated to be within the scope of the present invention.

Template Creation

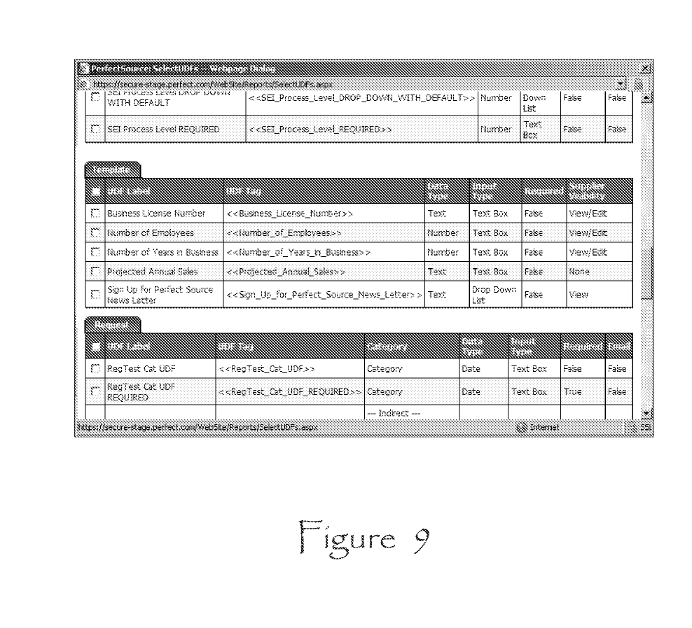

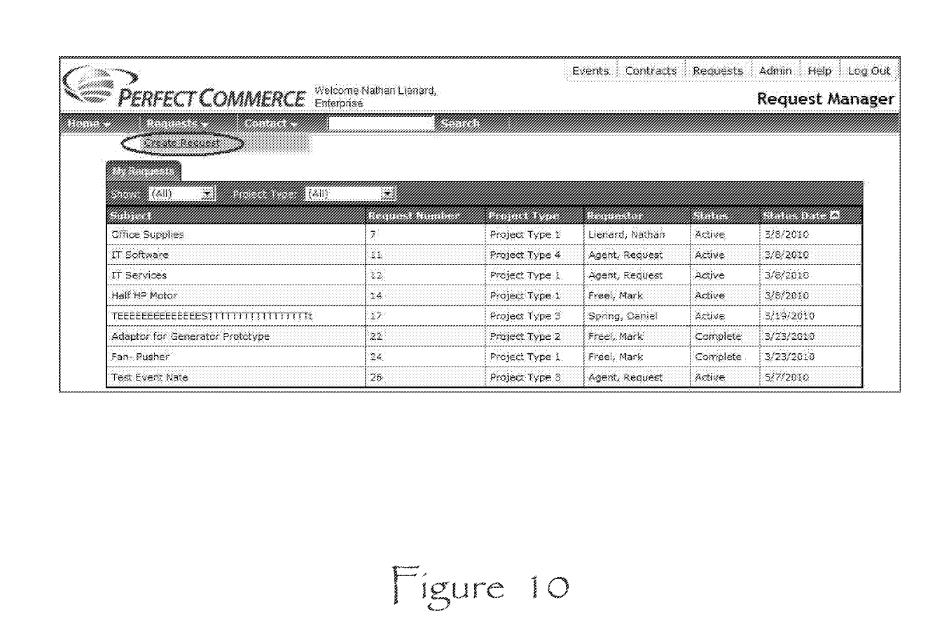

A sourcing agent with appropriate permissions is able to create/delete/modify a request template, as shown in FIG. 2. From the Request Manager home page, the sourcing agent selects “Create Request Template” from the “Request” drop down menu. See FIGS. 2 and 3. The sourcing agent can name the Template and choose a category to assign to the template. By clicking on the “Select” button associated with the Category the sourcing agent opens a list of potential categories that the template creator can select from. See FIG. 8. As desired, a sourcing agent can add UDFs to the template—see FIG. 9. By clicking the “Add” button a pop up menu of available UDFs organized by types—Global, Category, Template, and Request is displayed. Preferably, the template creator can select multiple UDFs. A user must select all of the UDFs that they wish to have on the template. For example, all of the Global UDFs will not automatically populate the template.

The sourcing agent can also delete a UDF that has been previously added to a template. To do so, the sourcing agent selects the check box next to the desired UDF and clicks the “Delete” button. This removes the UDF from the template. Additionally, the sourcing agent can add or delete Attachments to the template. By clicking “Add”, a standard pop up window opens that allows the template creator to browse for an attachment and add it to the template. The sourcing agent can click the check box next to an attachment and click the “Delete” button. This removes the attachment from the template.

When completed, the sourcing agent can save the template by clicking the “Save” button in the upper left corner. Alternatively, the sourcing agent can cancel the creation of the template by clicking the “Cancel” button in the upper left corner. The templates of the present invention provide significant advantages over the prior art. Information is shared between the user and the receiver as well as other users in order to increase the availability of information for users. The templates created by users or sourcing agents become a part of a library of templates utilized by multiple users.

The standardization within this library of templates allows the receiver to evaluate requests cumulatively. Requests are automatically categorized and accumulate on the user's dashboard making them available upon request. Thus, the value of information provided in each request is enhanced by being communicated through the request manager system. In addition, the templates in RM sustain value. Even after the request itself is removed from the system, the blank template and its inherent value as a customized tool remains. Although, purchase requests in the prior art may be repeated, or even repeated with minor alterations, the value created in structuring the request is lost upon deletion.

Completing a Request

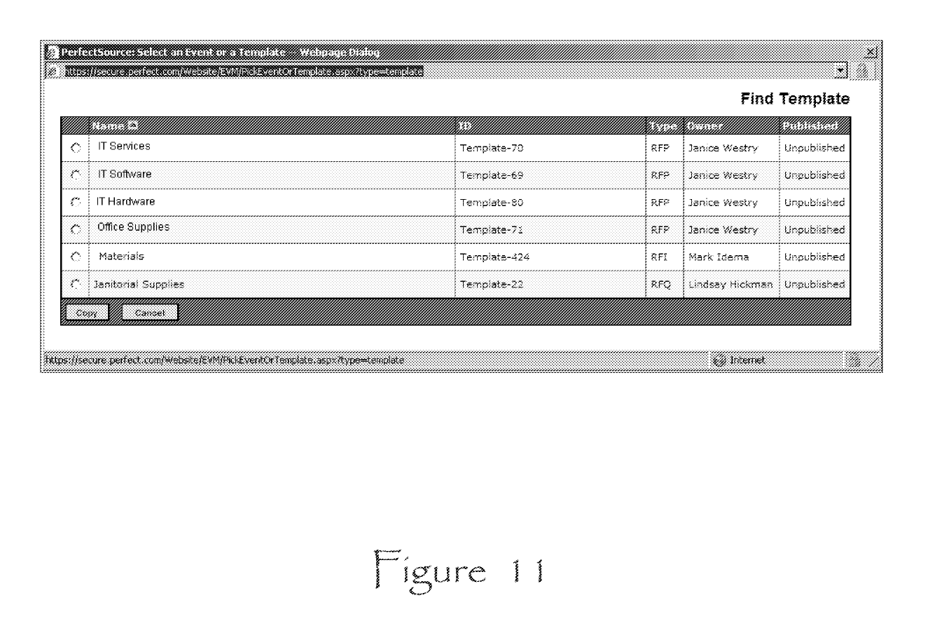

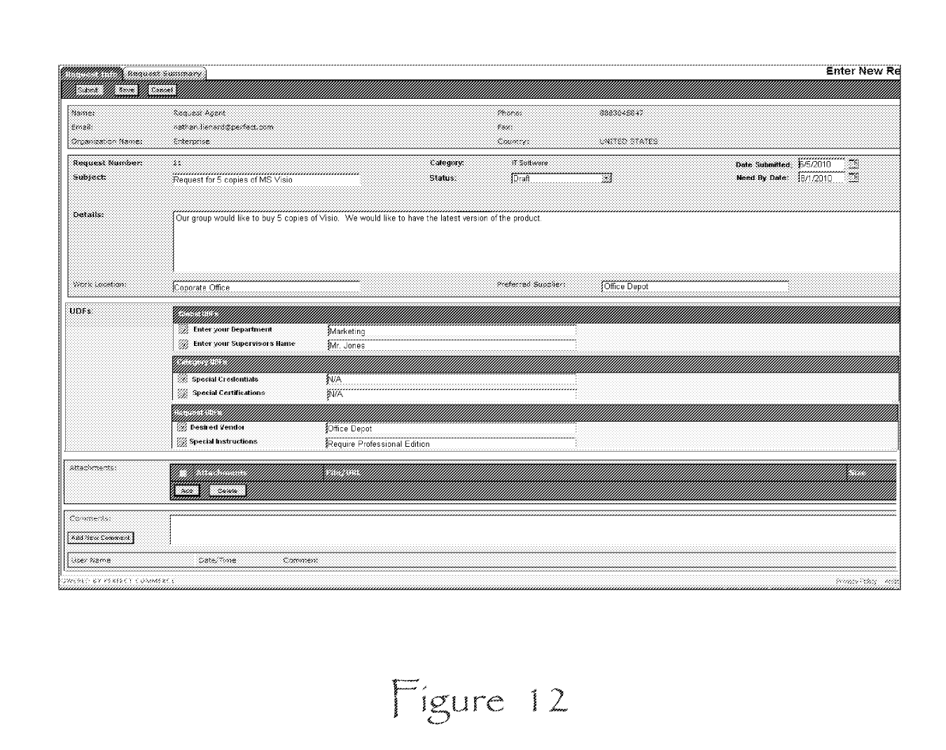

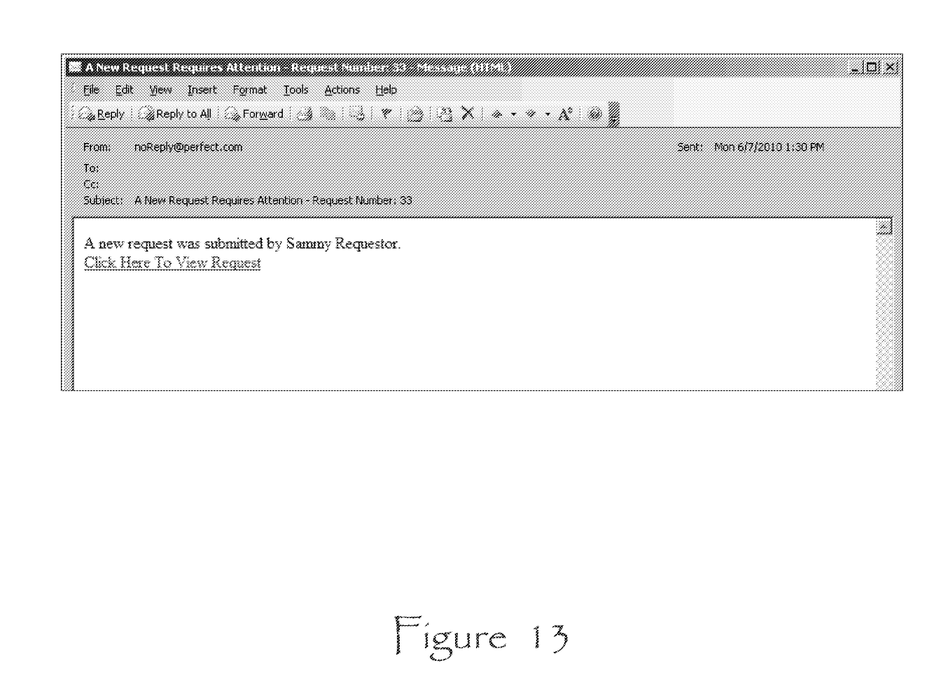

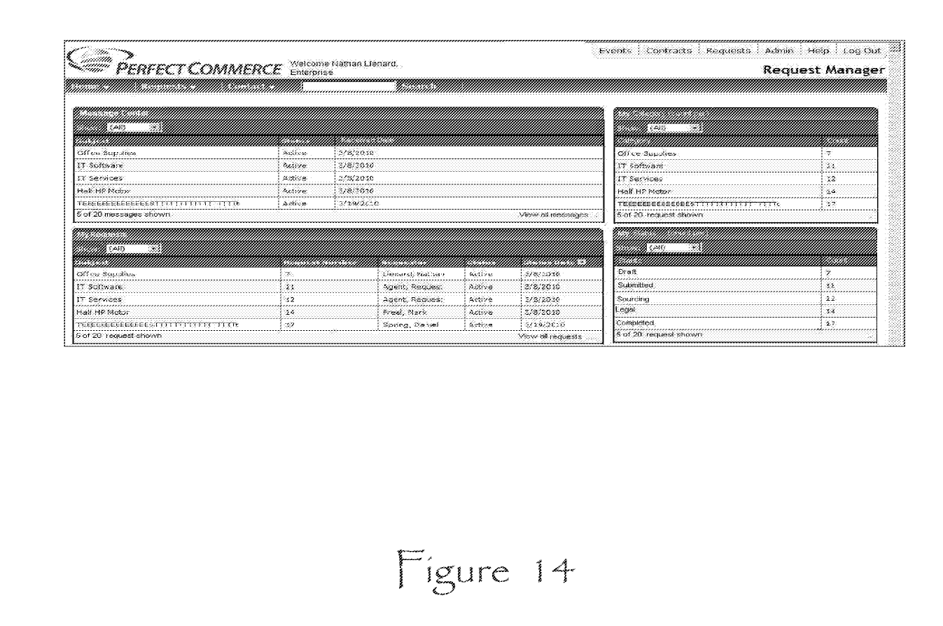

From the Request Manager home page, the first user requester can click on “Create Request” under the “Request” drop down menu. See FIG. 10. A pop up box then displays a listing that the available templates that the requesting agent can choose from, as shown in FIG. 11. Preferably, radio buttons are provided next to each template. Once the desired template has been selected, the requestor can select the copy button. The requestor fills out the template, adds attachments if necessary, add comments if needed, and clicks the submit button. See FIG. 12. Upon clicking submit, the designated sourcing agent(s) receive a notification stating that a new request has been submitted, as shown in FIG. 13. If the sourcing agent adds comments, adds attachments, or changes the status of the request, the requesting agent will receive a notification.

Receiving/Working a Request

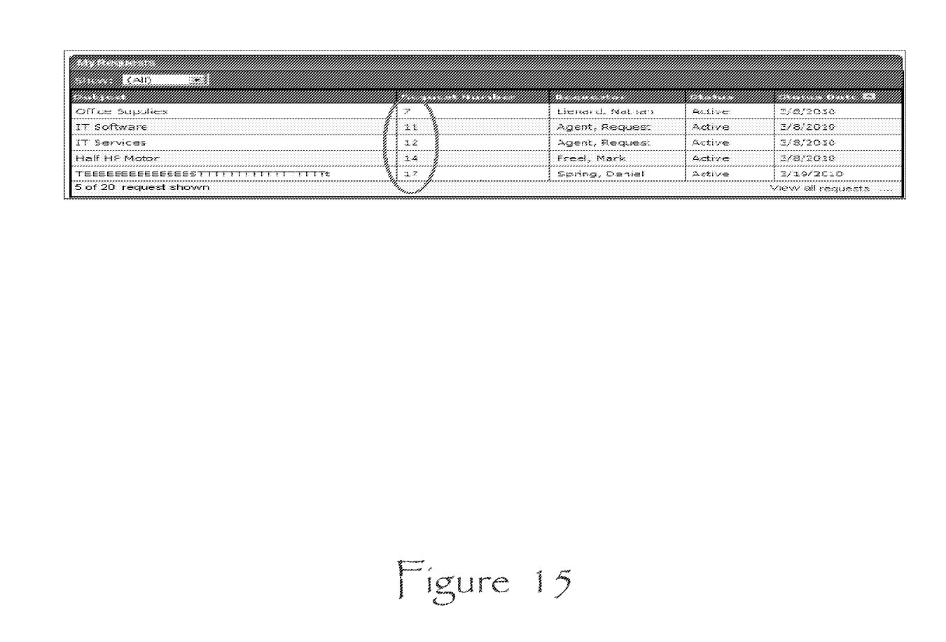

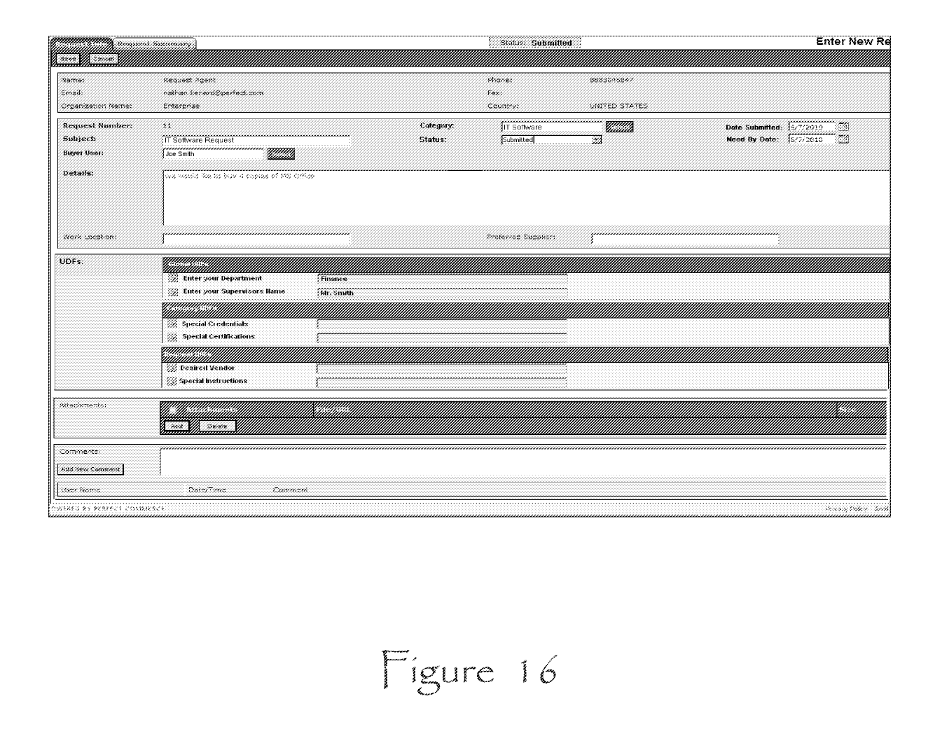

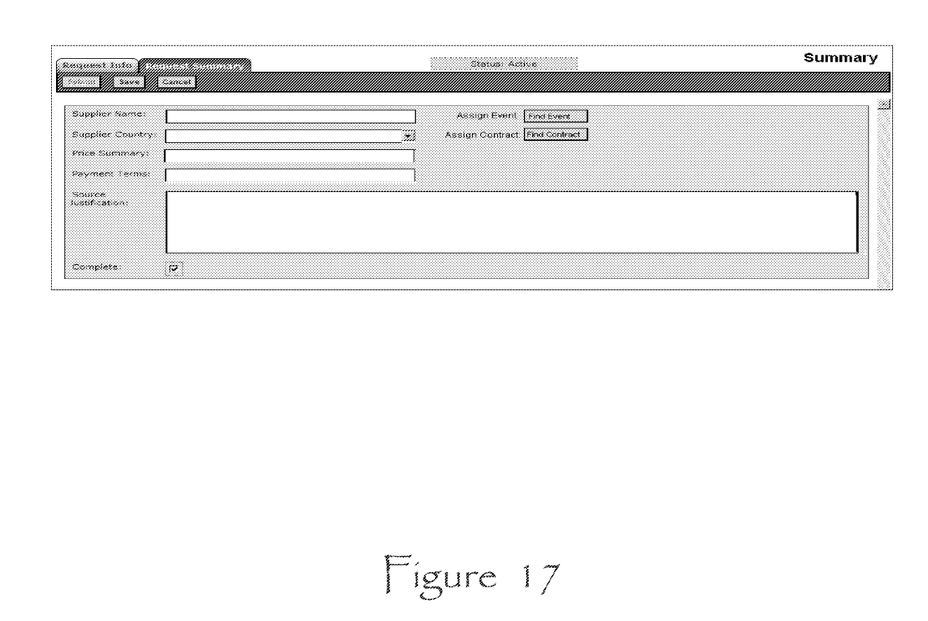

From the Request Manager home page, the sourcing agent has a quick view of the most recent requests. See FIG. 14. Clicking on one of the request opens the request, as shown in FIG. 15. The sourcing agent can also click on the link provided in the notification that a new request has been received, as shown in FIG. 13. The sourcing agent can complete the request him or herself by filling out the summary tab of the request or assign the request to a buyer user. FIG. 16 shows an example of a sourcing agent's view of a request and FIG. 17 shows an example of a summary tab. If the request is assigned to another user, the assigned user receives a notification. Additionally, if the requesting agent adds comments, adds attachments, or changes the status of the request, the sourcing agent receives a notification. If an event and/or a contract are created as a result of the request, a buyer user can assign the appropriate event and/or contract to the request. Upon completing the request, the sourcing agent can change the status to “Completed” (or any other label that has been designated as the “Completed” status) on the summary tab.

Creating Roles

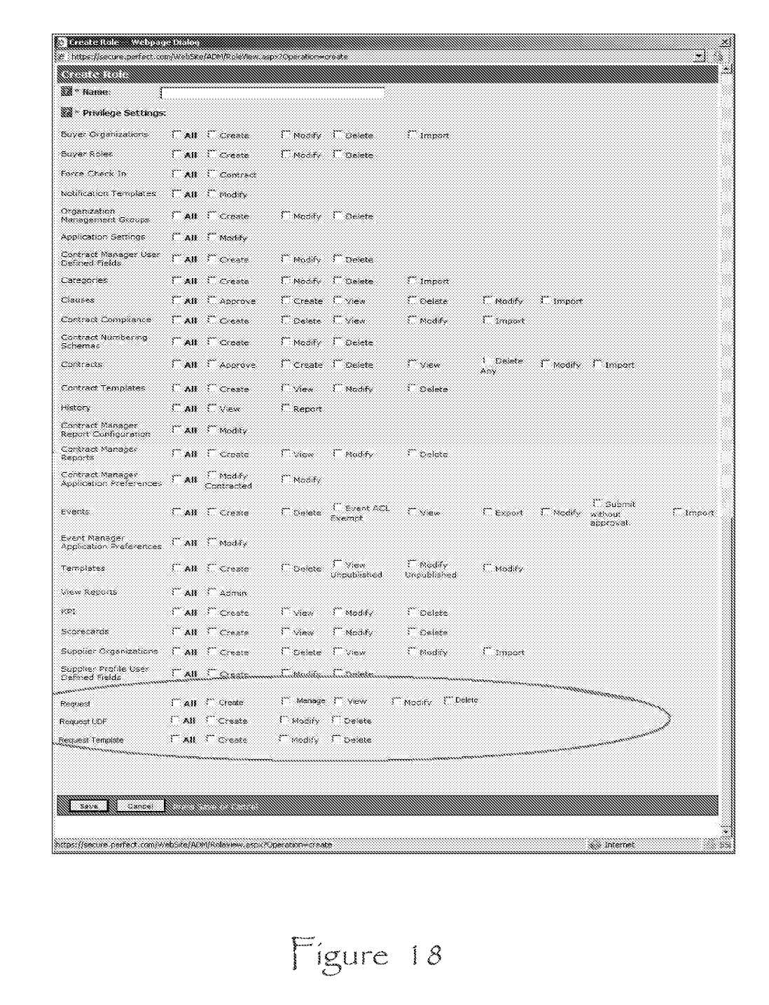

There are four available Privilege Setting groupings related to Request Manager—Request, Request Template, Request UDF, and Request Manager Application Preferences. See FIG. 18.
Request—Select appropriate check boxes to allow users to:
   Create—Allows a sourcing agent to create a request. User will be able to log in and be able to submit requests.
   Manage—A user with the Manage Request permission will receive the initial request and may assign requests to other users.
   Delete—Allows a user to delete requests.
   Modify—Allows a user to make changes to requests.
   View—Allows a user to view requests.
Request Template—Select appropriate check boxes to allow users to:
   Create—Allows a sourcing agent to create a request template.
   Delete—Allows a user to remove request templates.
   Modify—Allows a user to make changes to request templates.
Request UDF—Select appropriate check boxes to allow users to:
   Create—Allows a sourcing agent to create request-related User Defined Fields (UDF).
   Delete—Allows a user to remove a request-related User Defined Field (UDF).
   Modify—Allows a user to make changes to a request-related User Defined Field (UDF).
Request Manager Application Preferences—Select appropriate check boxes to allow users to:
   Modify—Allows a user to manage the various Application Preferences associated with Request Manager. This includes:
   Designating the default role that will be assigned to all users who self-register to use Request Manager.
   Managing Request Manager related Statuses that identifies where in the process the Request is.
   Managing Request Manager related Notifications including the email address and displayed name that appear on the notifications.

Application Management

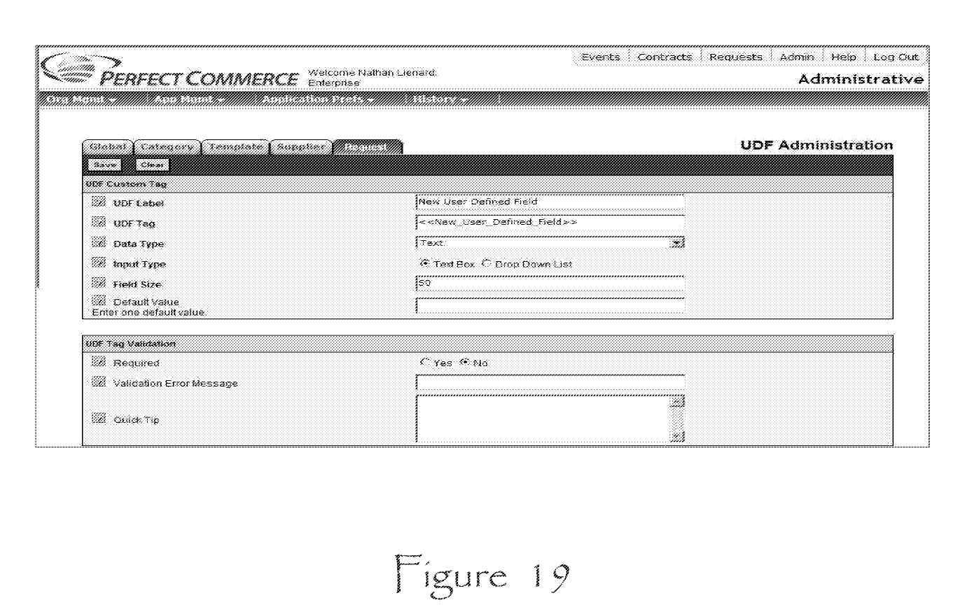

User Defined Fields (UDFs) allow Buyers to create unique fields in Request Manager to capture specific information. All UDFs are available when creating and building Request Templates. Request Templates are the foundation of all requests. With the correct privileges, a user can create a new UDF by clicking the “Create” button as shown in FIG. 19. The Create UDF page displays the fields that are required to create the UDF. Complete these fields as follows:
UDF Custom Tag—Data entered in this section will affect the UDF appearance and accessibility, as well as the history and reporting.
   UDF Label—Enter the label for the tag. The label should be descriptive of the information requested.
   UDF Tag—This tag is a unique identifier that will represent the UDF in the document. When the request is generated, this tag will be replaced with the actual value of the UDF. The tag must be surrounded by <<and >> symbols and may not contain any spaces.
   Data Type—Use the Drop Down menu to define the type of data that will be entered into the UDF. Options include Currency, Text, Date, and Number. One option must be selected.
   Input Type—Select one of the radio buttons to indicate whether the data input will be by Text Box or a Drop Down List.
   Field Size—Enter the maximum value for the field size in this box using only numeric values. If Drop Down List was selected as the Input Type, the Form List Values field will appear in place of this field. The maximum value is 500.
   Form List Values—This text box appears only when the Input Type selected is Drop Down List. Use this text box to specify the options that can be selected to complete the UDF. Add one option per line, in order of appearance within the Drop Down list.
   Default Value—Enter a default value for the input field, if desired.
UDF Tag Validation—This section provides validation parameters for the UDF. This section is not required if default values are utilized.
   Required: Select No, the default value, if the field is not required. Select Yes if the field is required. When Yes is selected the Validation Error Message field will be required.
   Validation Error Message: Enter an error message that the user will see if the field input is incorrect. If the Yes radio button was selected in the required field, then this Validation Error Message field is required.
   Quick Tip: Enter information that will assist the user in completing the UDF. This information will display when the user hovers over the Quick Tip Help icon, so keep the message short and descriptive.

The user can then click Save to create the UDF. The new UDF appear in the list of Request UDFs. In some embodiments, the user can create Drop Down List UDFs, Text UDFs, Currency UDFs using either a text box or a drop down list, Date UDFs using either a text box or a drop down list, and Number UDFs using either a text box or a drop down list.

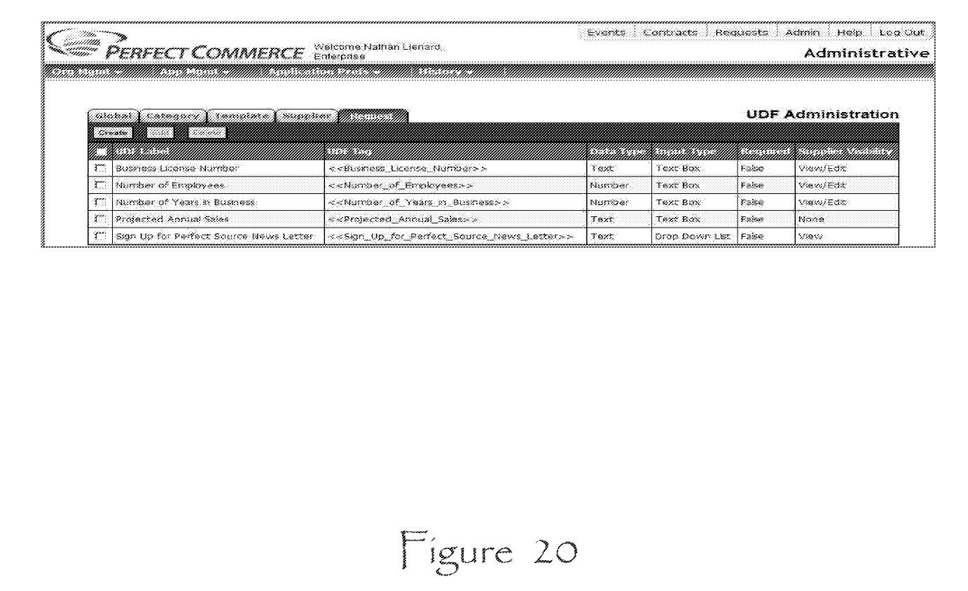

With the correct privileges, a user can edit an existing UDF by selecting the desired UDF and clicking the “Edit” button as shown in FIG. 20. With the correct privileges, a user can delete an existing UDF by selecting the desired UDF and clicking the “Delete” button. A confirmation message will appear asking the user to confirm that they would like to delete the selected UDF.

Application Preferences are tools designed for customizing the application for the unique enterprise. Only Administrators with the ability to modify Application Settings are able to edit Application Preferences. FIG. 21 shows an illustration of an Admin Screen according to the present invention. An Administrator adds the role of Request Manager Application Preferences to their own profile in order to access this page. “Request Manager” is located under the “Application Preferences” section in Admin. “Request Manager” is also available by the drop down menu “Application Prefs”. An administrator may click on “Request Manager” from the drop down or on the Admin home screen and go to “Request Manager Application Preferences” as shown in FIG. 22. An administrator can set the default role that is assigned to a requestor once they complete the RSR, as described above. Roles are created in the Organization Management section of the Admin utility. Only those roles that contain “Request” privileges are included in the drop down menu. The Request Manager Application Preferences allow users to establish application settings that are specific to Request Manager. Users can select the default requester role or create, modify, and delete request statuses.

This section of the Request Manager Application Preferences page also allows Request Manager Administrative Users to configure the available statuses for organization. Requests will always fall into one of three primary categories—Draft, Submitted, or Completed. In some embodiments, the primary categories cannot be changed; however, child statuses may be added, deleted, renamed, or re-ordered. A “child” status is a subset of the primary category that may be created by an administrator to facilitate use of the program. In some embodiments, additional primary categories may be created by the administrator. From the “Request Manager” tab, an admin can provide alternative names for “Draft”, “Submit”, and “Completed. The help tips for these three may include language such as the following—“This field lets you customize the “Draft” status to better match your organization's commonly used terminology.” The word “Draft” can be changed to match “Submit” and “Completed”.

Draft—Requests that have not yet been submitted to the sourcing team.

Submitted—Requests currently being worked by the sourcing team.

Completed—Requests that have been fulfilled or rejected and required no further action.

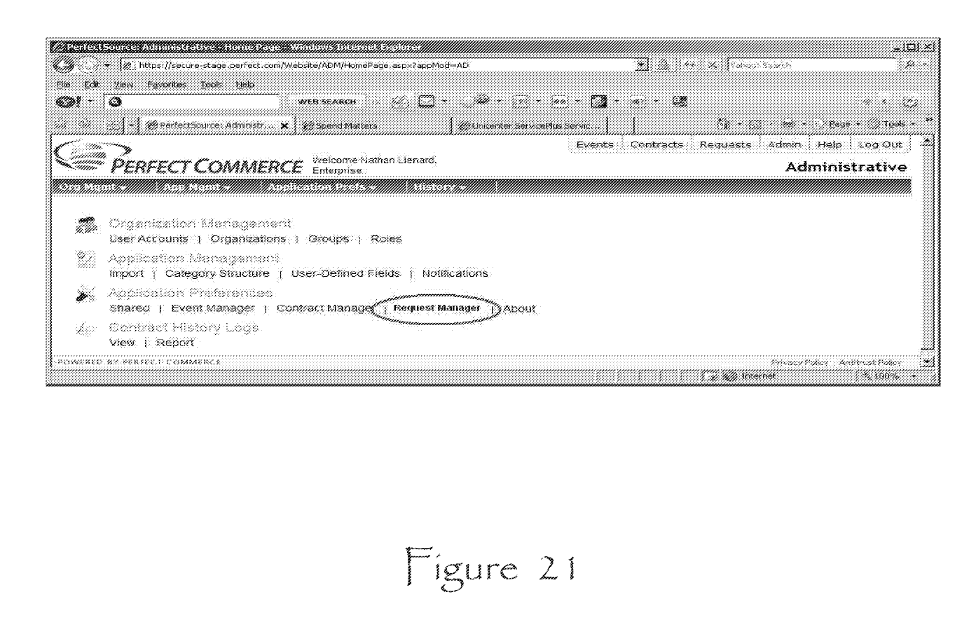

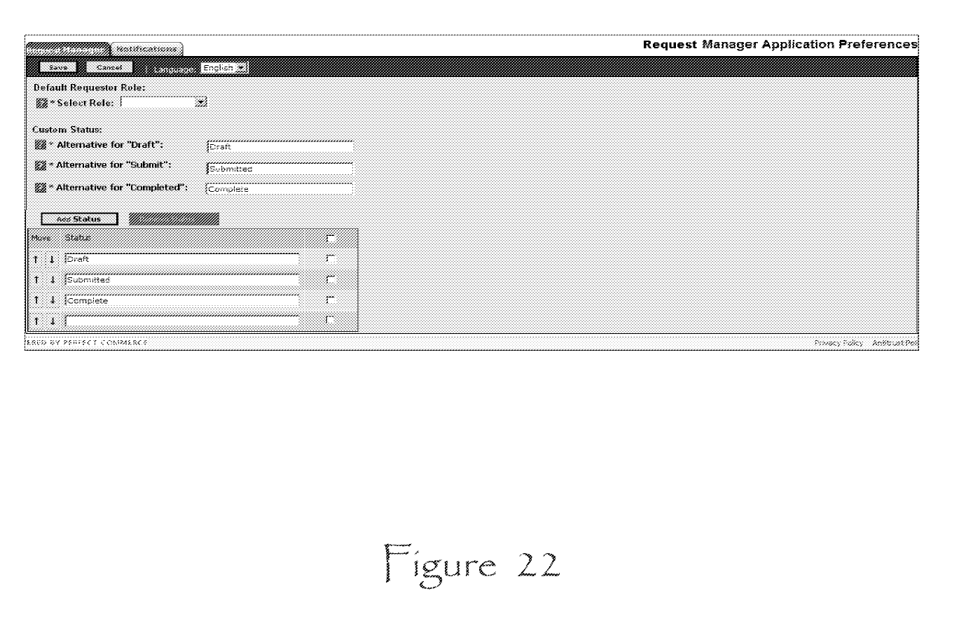

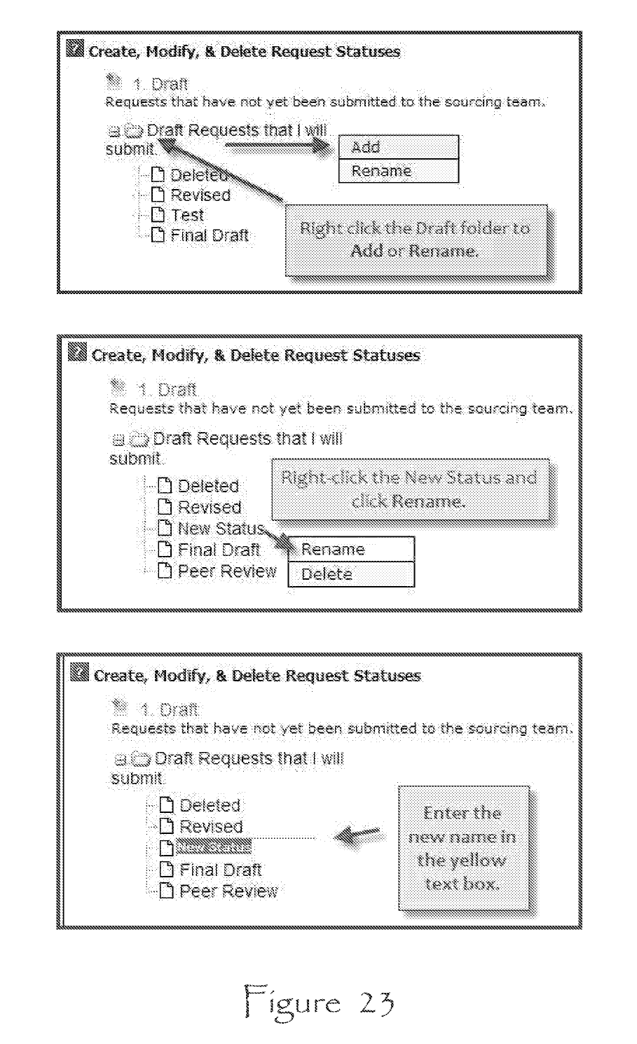

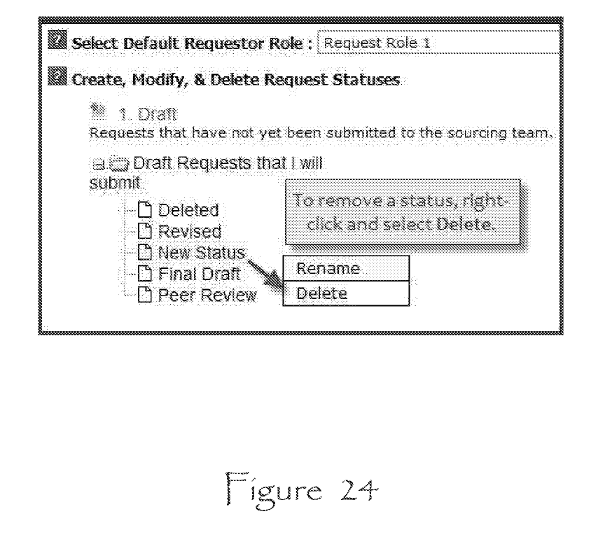

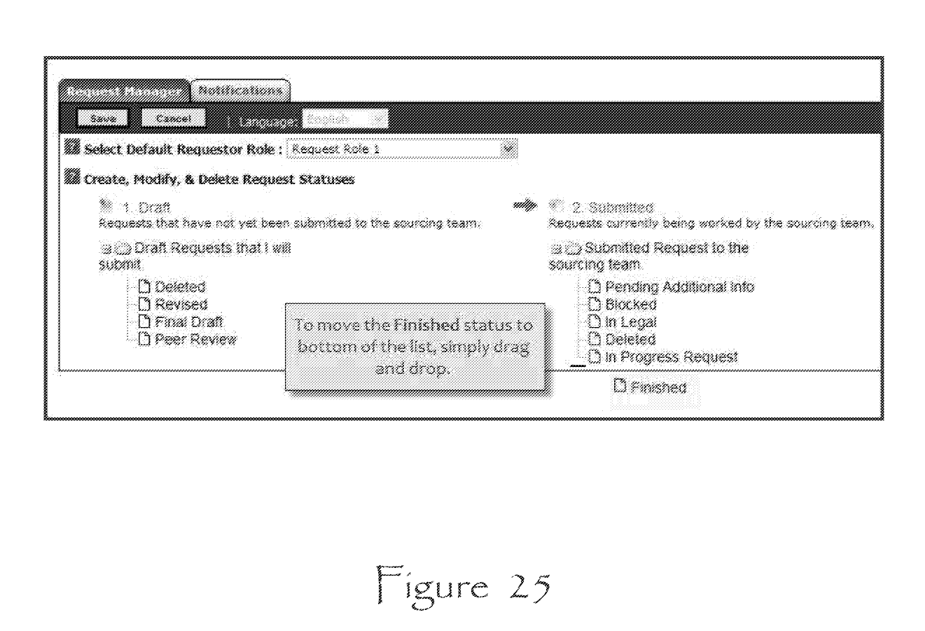

This field lets an operator customize the Abbreviation and Full Name for RFI event types, based on their organization's commonly used supply chain terminology. Users must be in Edit mode to make any and all changes. Additional statuses may be added, if desired. To add a child status, right-click the folder that the status will reside. In the example shown in FIG. 23, a child status is added to the Draft primary category and renamed. Right-click the folder and select Add. A New Status will appear in the list, simply right-click the New Status and select Rename. Be sure to hit Save to commit all changes. Cancel discards all edits and returns the page to read-only. The folder that contains the child statuses, as well as the child statuses themselves, may be renamed. Right-click the folder or child status name and select Rename. Additionally, the additional statuses can be removed, but the required statuses (Draft, Submit, and Completed) cannot be removed. To remove a status from the list, simply right-click the status and select Delete. See FIG. 24. A confirmation dialog box will open. Click OK to proceed with deletion. The page will refresh and the status will have been removed. Cancel ends the deletion and the status remains in the list. After deletion, be sure to hit Save to commit all changes. Cancel discards all edits and returns the page to read-only. Additional statuses added by the user can be moved up and down as shown in FIG. 25 to accommodate the desired order of the statuses. To change how the lists are displayed under each of their primary categories, click a status to select it. Once the status is selected, simply drag and drop it to its new location. A status may not be moved between categories. For example, in FIG. 25, the Blocked status may not be moved from the Submitted category to the Draft category. It may only be moved within the Submitted category. Child statuses may not have their own child statuses. For example, in FIG. 25, the Blocked status may not be a child status under the In Legal status.

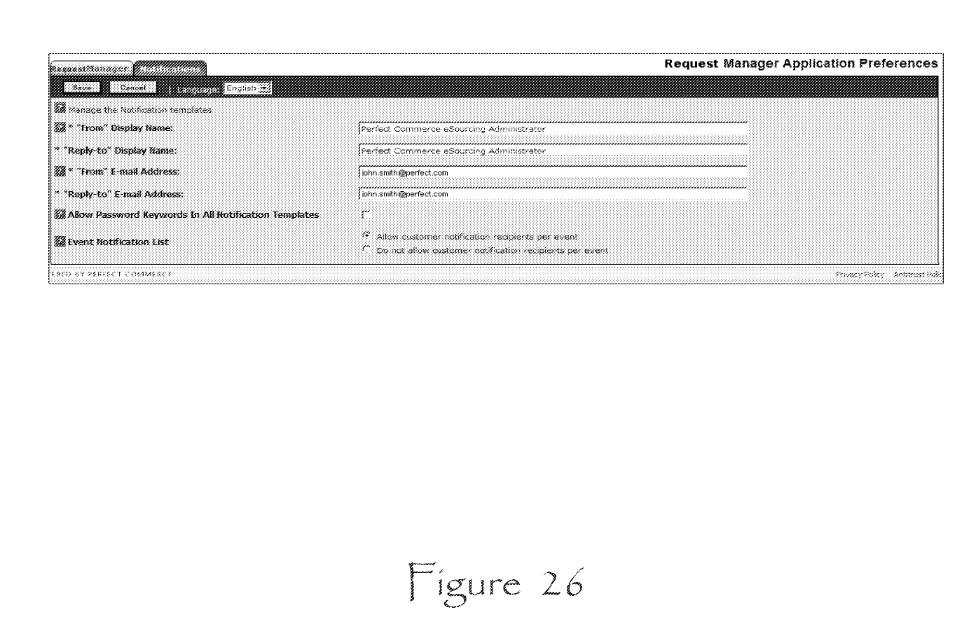

As shown in FIG. 26, from the “Notifications” tab, an admin can configure the following:
1. “From” Display Name
2. “Reply-to” Display Name
3. “From” E-mail Address
4. “Reply-to” E-mail Address
5. Allow Password Keywords In All Notification Templates
6. Event Notification List

To make changes to the Display Names and E-mail Addresses for the automated Request Manager related notifications, click Edit. For the Display Name, enter the name of the person, department, or organization that should appear in the From field of the automated email notifications. Enter the name of the person, department, or organization that should appear in the Reply To field of the automated email notifications. For the E-mail Address, enter the complete email address for the recipient or group that should appear in the From Email Address field of the automated email notifications. Enter the complete email address for the recipient or group that should appear in the Reply To Email Address field of the automated email notifications.

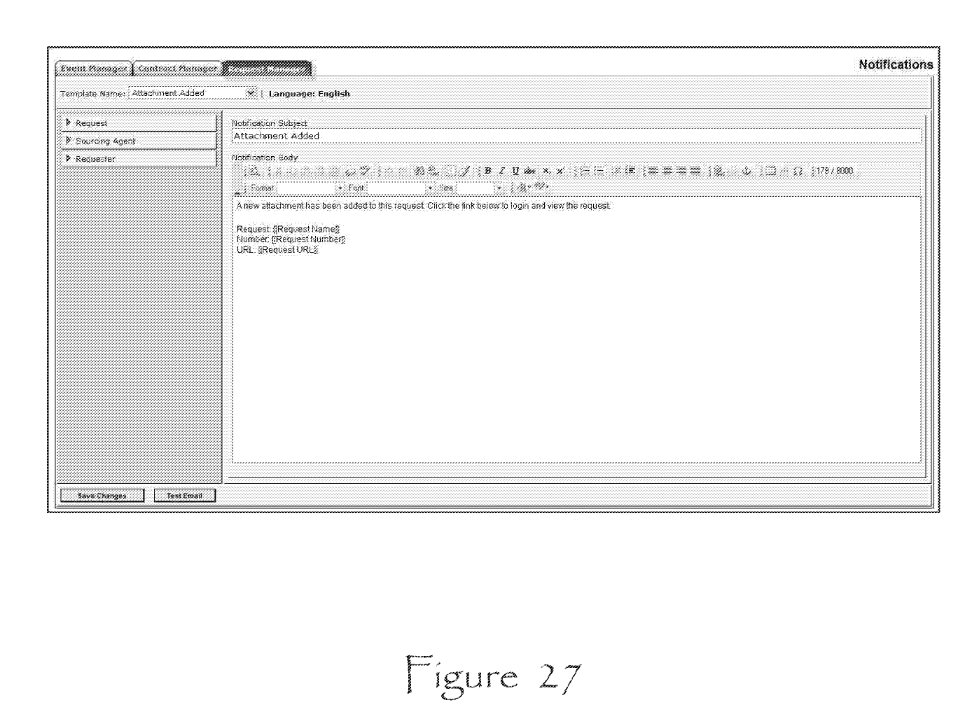

The Notifications settings allow the administrator to modify templates for the notification e-mails that are sent to Request Manager Users at various stages of a request. These notifications are triggered by specific occurrences in a request. Preferably, the Notifications developed for the Request Manager are standard. In some embodiments, new notifications cannot be created. See FIG. 27, from this page, the administrator can:
Modify notification content in the Subject and Body sections of the notifications.
Add and remove keywords that Notification templates that will update with request-specific details.

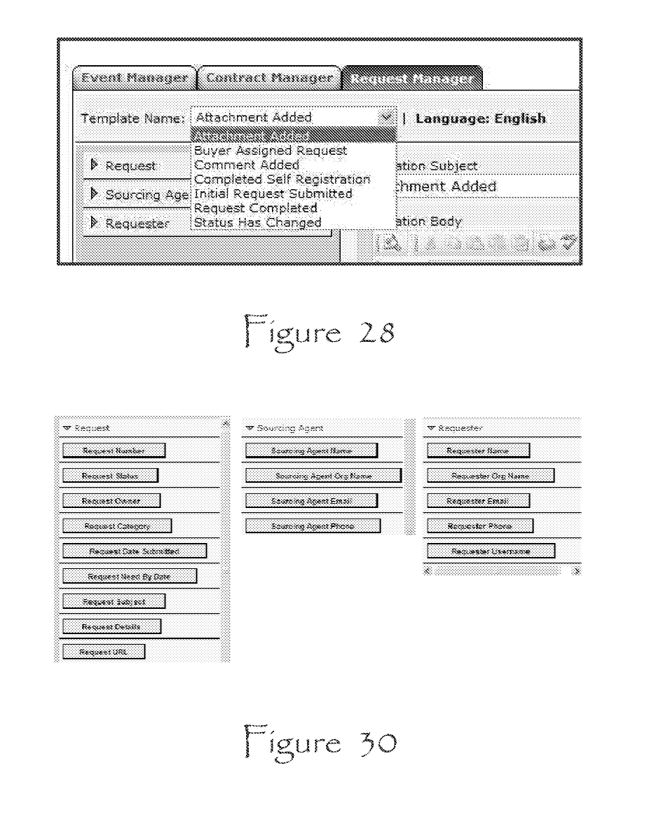

To modify Notifications, select the Request Manager tab for request related notifications. To select a template for modification, open the Drop Down menu next to the Template Name field as shown in FIG. 28. Select a template by highlighting the name. The page will refresh and display the template details. The right side of the screen displays the Notification Subject and Body. The left side of the email displays links to keywords that may be added to the template.

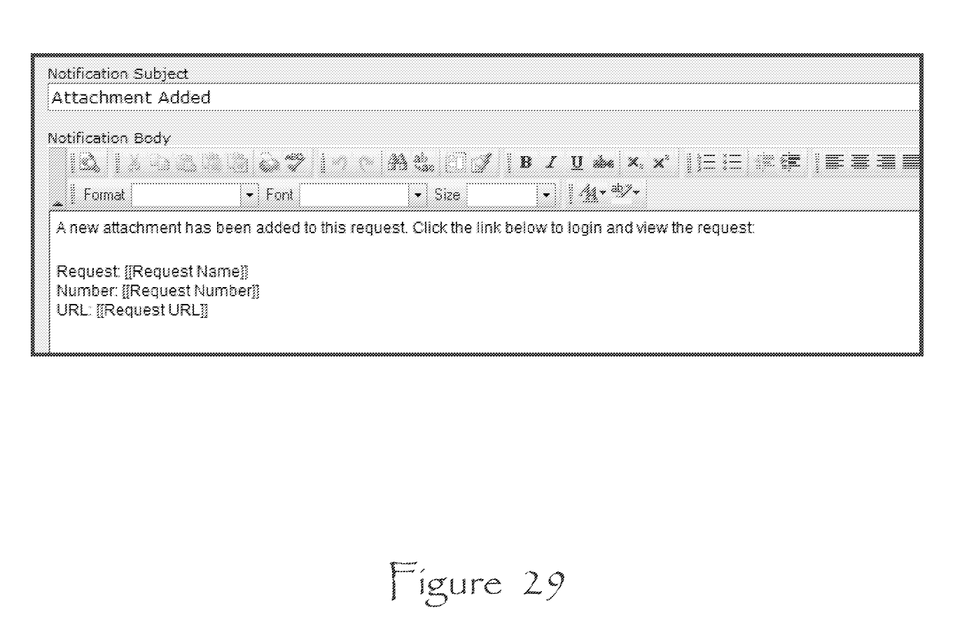

The content in the Subject and Body sections of the template may be modified by placing the cursor in the appropriate place and entering new content or modifying existing content. See FIG. 29. These notifications are viewed by all Request Manager Users with appropriate privileges. Changes will be visible to all recipients of the notifications.

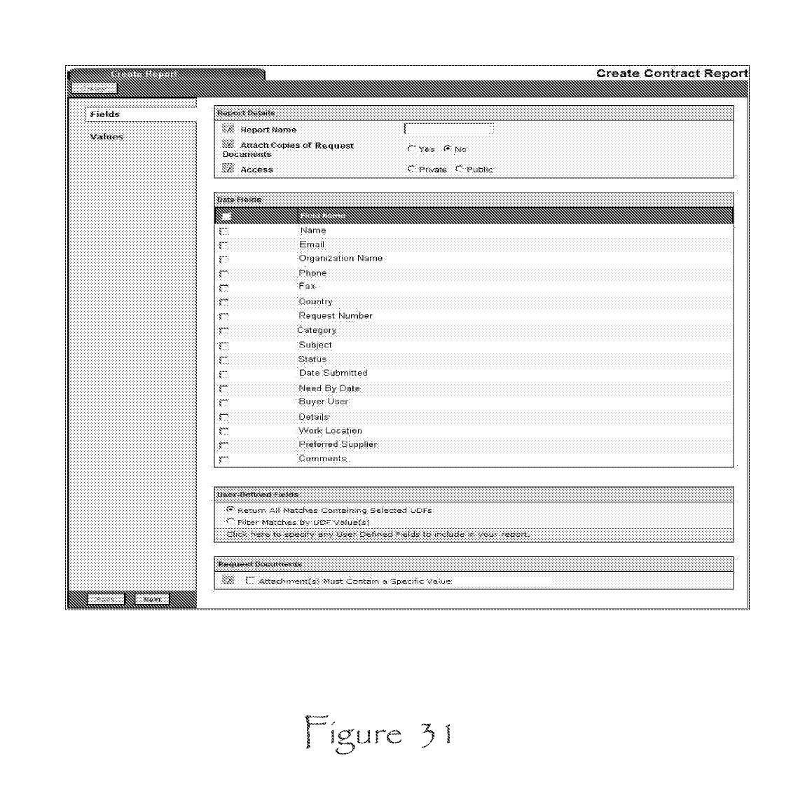

The keywords in notifications are items enclosed in double brackets [[ ]]. Each of these items represents request specific information that will populate from the request that the notification is being generated. To add one or more key words, place the cursor in the Notification Body section of the template where the keyword should appear and click the appropriate keyword in the left side of the screen. When a linked name is clicked, a series of buttons display, such as shown in FIG. 30.

When these keywords are added to a notification, the notification displays the information associated with the keyword that is relevant to the current request. For example, the [[Request Number]] keyword in a notification will display the number of the request. The following are examples of types of keywords, which can be added to notification templates:
Request—Request-related information including Request Number, Request Name, Status, Owner, Category, and more.
Sourcing Agent—Buyer-related information all information related to Buyers, including name, ID and address and contact information.
Requester—Include the name of the Requester, Requester's Organization Name, Email, and Phone in the selected notification.

To add an element, place the cursor where the keyword should appear within the content. Open the keyword by clicking the name link. Then add the element by clicking the appropriate button. More than one keyword may be added to a notification. For example, if adding a Requester Name and Requester Organization, each button would be selected to insert the name and organization. When the appropriate elements have been added, click Save Changes to keep the changes. Click Test Email to view an email that will display the modified notification information.

To remove a keyword from a notification template highlight it, including the double brackets [[ ]] and use the Delete key. When a keyword has been removed from a notification template, it will no longer appear in any notification generated from that template.

Reports

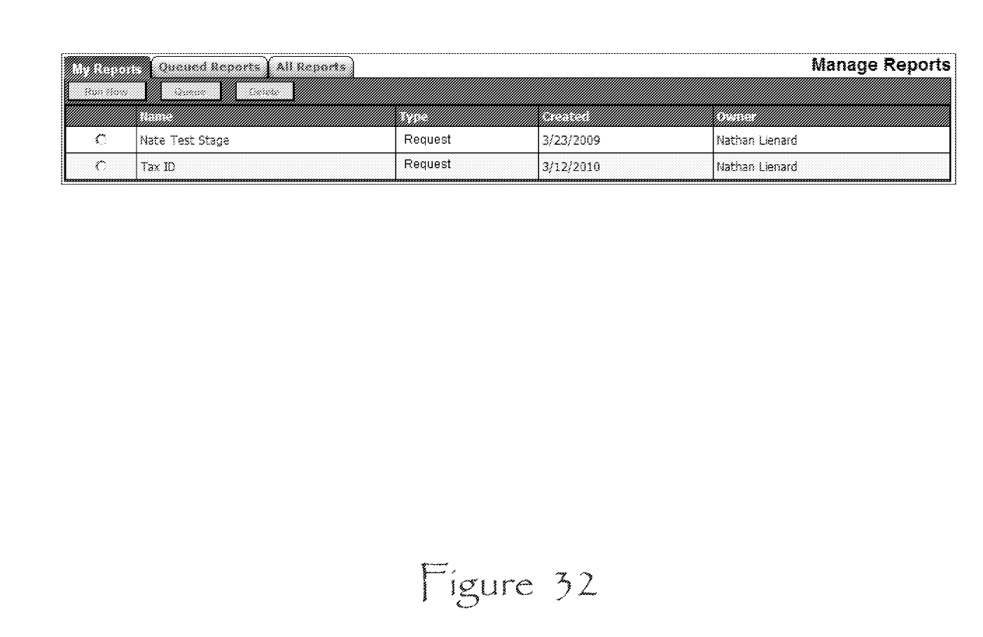

In a preferred embodiment, there will be the ability to create a report with the desired fields and UDFs—See FIG. 31. Preferably, a buyer user can save reports and search for them, as shown in FIG. 32.

It will be appreciated by persons skilled in the art that numerous variations and/or modifications may be made to the invention as shown in the specific embodiments, without departing from the spirit or scope of the invention as broadly described. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood that the invention may be practiced otherwise than as specifically set forth herein. The present embodiments are, therefore, to be considered in all respects as illustrative and not restrictive.

1. A method for managing sourcing programs, comprising:
collecting a sourcing request for a sourcing program through a first computer interface;
presenting the sourcing request to a sourcing agent in a sourcing department through the first computer interface;
enabling the sourcing agent to implement a computer implemented sourcing protocol; and
receiving a list of sourcing results in response to the sourcing protocol.

2. The method of claim 1, wherein the sourcing request comprises a request for a change in an existing sourcing program.

3. The method of claim 1, wherein the sourcing protocol is initiated through a second computer interface.

4. The method of claim 1, wherein said first computer interfaces is hosted on a server and said server is a physical server or a virtual server.

5. The method of claim 1, wherein the first computer interface and the second computer interface are selected from the group consisting of a website and a mobile device application.

6. The method of claim 1, wherein the sourcing protocol is a competitive bidding process selected from the list consisting of a RFx, Request for Information, a reverse auction, a Request for Proposals, and a Request for Quotes.

7. The method of claim 1, further comprising the step of providing a sourcing request template.

8. The method of claim 7, further comprising the step of enabling creation of the sourcing request template by an administrator.

9. The method of claim 7, wherein the sourcing request template fields are selected from customized fields used in either or both of a contract management application or an event management application.

10. The method of claim 1, wherein the request is assigned a custom category selected from a list of previously established custom categories, which match categories used in either or both of a contract management application or an event management application.

11. The method of claim 1, further comprising the step of allowing the sourcing agent having a unique user ID authenticated by the sourcing program to assign the sourcing request to a second sourcing agent having a unique user ID authenticated by the sourcing program.

12. The method of claim 1, further comprising the step of storing an automatic reference that allows a user to subsequently view the actual request content by clicking through the history of an event.

13. The method of claim 1, further comprising the steps of:
collecting sourcing request data,
storing said sourcing request data in a database,
alerting a sourcing agent of the sourcing request, and
enabling the sourcing agent to transfer data from the sourcing request into an RFx.

14. The method of claim 1, further comprising the steps of:
obtaining sourcing proposals from the sourcing protocol,
determining whether the existing sourcing program should be modified based on the results of the sourcing protocol, and
modifying the existing sourcing program or maintaining the existing sourcing program.

15. A computer program product for managing an organization's sourcing programs by collecting data from through a first user interface in the form of a sourcing request, presenting that data through the first user interface, enabling the initiation of a sourcing protocol and presenting the results of the sourcing protocol, the computer program product comprising a non-transitory computer readable medium storing computer-readable program code, the computer readable program code comprising:
a set of instructions for collecting a sourcing request for a sourcing program through a first computer interface;
a set of instructions for presenting the sourcing request to a sourcing agent in a sourcing department through the first computer interface;
a set of instructions for enabling the sourcing agent to initiate a sourcing protocol; and
a set of instructions for receiving a list of sourcing results in response to the sourcing protocol.

16. The computer program product of claim 15, further comprising:
a set of instructions for collecting sourcing request data,
a set of instructions for storing said sourcing request data in a database,
a set of instructions for alerting a sourcing agent of the sourcing request, and
a set of instructions for enabling the sourcing agent to transfer data from the sourcing request into an RFx.

17. The computer program product of claim 15, further comprising:
a set of instructions for obtaining sourcing proposals from the sourcing protocol,
a set of instructions for determining whether the existing sourcing program should be modified based on the results of the sourcing protocol, and
a set of instructions modifying the existing sourcing program or maintaining the existing sourcing program.

18. A computer system for optimizing sourcing costs, comprising:
a sourcing department computer configured to receive a sourcing request for a change or evaluation of an existing sourcing program;
a requesting department computer connected with said sourcing department computer; wherein said requesting department computer has access to a user interface comprising at least one sourcing request template for transmitting said sourcing request for a change or evaluation of the existing sourcing program;
a server connecting said requesting department computer and said sourcing department computer; wherein said server is equipped with one or more software applications that permit a requesting department to submit said sourcing request for a change or evaluation of said existing sourcing program or creation of a new sourcing program; and
a non-transitory computer readable medium storing computer-readable program code, the computer readable program code comprising instructions for managing sourcing requests utilizing said server, said sourcing department computer, and said requesting department computer.
